(19) United States
(12) Patent Application Publication
(10) Pub. No.: US 2016/0037003 A1
(43) Pub. Date: Feb. 4, 2016

(54) MANAGEMENT SYSTEM AND CONTROL APPARATUS AND CONTROLLING METHOD SUITABLE FOR MANAGEMENT OF TONER

(71) Applicant: KYOCERA Document Solutions Inc., Osaka (JP)

(72) Inventor: Toyoaki OKU, Osaka (JP)

(73) Assignee: KYOCERA DOCUMENT SOLUTIONS INC., Osaka (JP)

(21) Appl. No.: 14/815,227

(22) Filed: Jul. 31, 2015

(30) Foreign Application Priority Data
Jul. 31, 2014 (JP) 2014-156729

(51) Int. Cl. H04N 1/00; H04N 1/23

(52) U.S. Cl. CPC H04N 1/00344; H04N 1/00323; H04N 1/2346; H04N 1/00034; H04N 1/00042; H04N 1/00068; H04N 1/00832; H04N 2201/0094

(57) ABSTRACT

Provided is a control apparatus that manages expendable supplies appropriately so as a trouble unexpected to an image forming apparatus does not happen. An image forming apparatus has a detecting circuit that detects identification information of a container when replacing the container of expendable supplies and transmitting circuit that transmits event information including detected identification information to the control apparatus. The control apparatus has a receiving circuit that receives the event information. An identification information determining circuit of the control apparatus compares the identification information of the container included in the received event information with a management table that manages shipped expendable supplies. Thereby, the identification information of the container corresponds to the shipped expendable supplies is determined. If not correspond to the shipped expendable supplies, the notice circuit notifies content that shows not corresponding to the image forming apparatus.

### INCORPORATION BY REFERENCE

This application is based on and claims the benefit of priority from Japanese Patent Application No. 2014-156729 filed on Jul. 31, 2014, the contents of which are hereby incorporated by reference.

### BACKGROUND

The present disclosure is related with, for example, a management system and a control apparatus and a controlling method, which are suitable for management of the toner.

An image forming apparatus is an MFP (Multifunction Peripherals), a printer, or the like that are MFPs. For an image forming apparatus, management of toner, or the like, which are expendable supplies, may be performed by a management system.

In addition, a management system connects an image forming apparatus for a side of a user with a remote managing server via the Internet, for example. The management system manages remaining toner amount of the image forming apparatus, or the like, by a managing server receiving status information, or the like, from the image forming apparatus side.

A typical example of the management system is to manage the remaining toner amount of such an image forming apparatus, or the like. In the management system, for replacement of a toner container, residual quantity information of toner is associated with the toner container and is kept, it can manage whether or not the toner container is exchanged in the middle of use. In this example, the notice of replacement is transmitted to the managing server. The notice of replacement includes identification information of the toner container newly-loaded with the image forming apparatus, counter information that shows system operating status at the time of replacement, and the residual quantity information of the toner included in the toner container extracted by the replacement. Then, based on the notice of replacement, a managing server associates the identification information, the counter information, and the residual quantity information of the toner container, and memorizes as management information.

### SUMMARY

A management system according to an embodiment of the present disclosure has an image forming apparatus and a control apparatus that manages the image forming apparatus, and comprises: the image forming apparatus includes a detecting circuit that detects identification information of a container of expendable supplies accompanying replacement of the container, a transmitting circuit that transmits event information including detected identification information to the control apparatus; and the control apparatus includes a receiving circuit that receives the event information, an identification information determining circuit that compares the identification information of the container included in received event information and a management table to manage shipped expendable supplies and determines whether the identification information of the container corresponds to the shipped expendable supplies, a notice circuit that notifies contents showing not corresponding to the image forming apparatus when the identification information of the container does not correspond to the shipped expendable supplies. A control apparatus related to the embodiment of the present disclosure comprises: a receiving circuit that receives event information including identification information of a container accompanying replacement of the container of expendable supplies from an image forming apparatus; an identification information determining circuit that compares the identification information of the container included in received event information and a management table to manage shipped expendable supplies and determines whether the identification information of the container corresponds to the shipped expendable supplies; and a notice circuit that notifies contents showing not corresponding to the image forming apparatus when the identification information of the container does not correspond to the shipped expendable supplies. A controlling method related to the embodiment of the present disclosure comprises the steps of: receiving event information including identification information of a container accompanying replacement of the container of expendable supplies from an image forming apparatus by a receiving circuit; comparing the identification information of the container included in received event information and the management table to manage shipped expendable supplies and determining whether or not the identification information of the container corresponding to the shipped expendable supplies by an identification information determining circuit; and notifying contents showing not corresponding to the image forming apparatus when the identification information of the container does not correspond to the shipped expendable supplies by a notice circuit.

### BRIEF DESCRIPTION OF THE DRAWINGS

FIG. 1 shows an embodiment a management system of the present disclosure;

FIG. 2 shows an example of a configuration of hardware of an image forming apparatus in FIG. 1;

FIG. 3 shows an example of a configuration of software of the image forming apparatus in FIG. 1;

FIG. 4 shows an example of a configuration of hardware of a managing server in FIG. 1;

FIG. 5 shows an example of a configuration of software of the managing server in FIG. 1;

FIG. 6 shows an example of an alarm that receives the managing server in FIG. 1;

FIG. 7 is a flow chart for explaining a process of the image forming apparatus in FIG. 1;

FIG. 8 is a flow chart for explaining a process of the image forming apparatus in FIG. 1;

FIG. 9 shows an example of a management table of a toner container managed by the managing server in FIG. 1; and

FIG. 10 is a flow chart for explaining a process of the managing server in FIG. 1.

### DETAILED DESCRIPTION

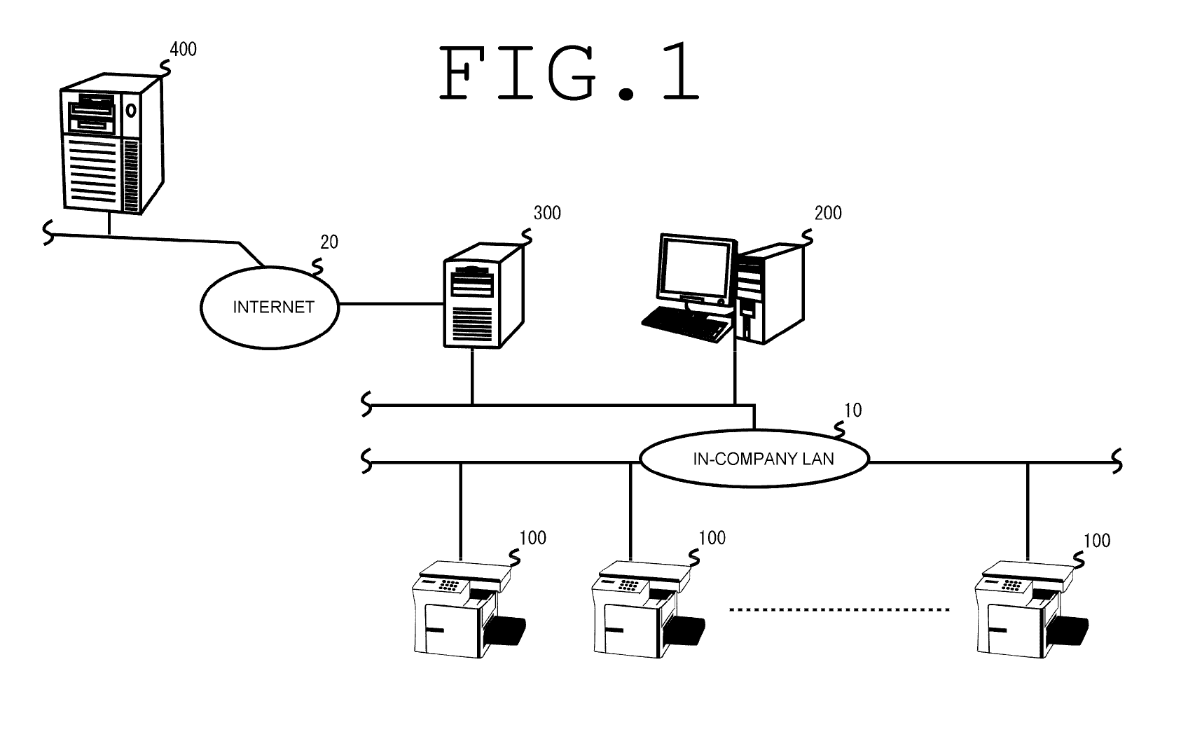

Hereinafter, an embodiment of the management system of the present disclosure is explained with referring to FIG. 1-FIG. 10. In the following explanation, the example of an image forming apparatus is an MFP (Multifunction Peripherals,) that has several functions.

As shown in FIG. 1, the management system includes MFP 100, base monitoring apparatus 200, firewall 300, and managing server 400. MFP 100, base monitoring apparatus 200, and firewall 300 are connected via in-company LAN 10. Firewall 300 and managing server 400 are connected via Internet 20.

Managing server 400 manages a plurality of MFP 100 via Internet 20. Thus, managing server 400 manages MFP 100 based on the monitoring information received from base monitoring apparatus 200. Also, managing server 400 performs management of toner, or the like, based on the after-mentioned event information of MFP 100. Firewall 300 prevents illegal network access to in-company LAN 10 from the outside.

Base monitoring apparatus 200 transmits monitoring information of MFP 100 acquired via in-company LAN 10 to managing server 400 on Internet 20. Base monitoring apparatus 200 is illustrated as a common PC (personal computer). However, base monitoring apparatus 200 is just an apparatus that executes a monitoring program. Base monitoring apparatus 200 collects monitoring information centralize from a plurality of MFP 100 that are present in in-company LAN 10 for a customer. Then, base monitoring apparatus 200 transmits the collected monitoring information to managing server 400. Thereby, efficiency, such as maintenance, can be improved.

In the present embodiment, MFP 100 has a function of self-monitoring. The monitoring information that MFP 100 transmits to managing server 400 includes various counter information showing a use condition and firmware information. In addition, monitoring information includes information of an error, alarm, or the like, in which an image-processing state is shown. Managing server 400 receives such monitoring information and provides service to a sales company. The service is a report display of a fee collection counter, failure event notification such as error alarm, calculation of consumption degree of components, management of toner inventory number, or the like. Especially, managing server 400 receives the event information about replacement of a toner in the monitoring information transmitted from MFP 100. Thereby, it is managed a toner is used efficiently and appropriately.

<The Example of a Configuration of the Control System of MFP 100>

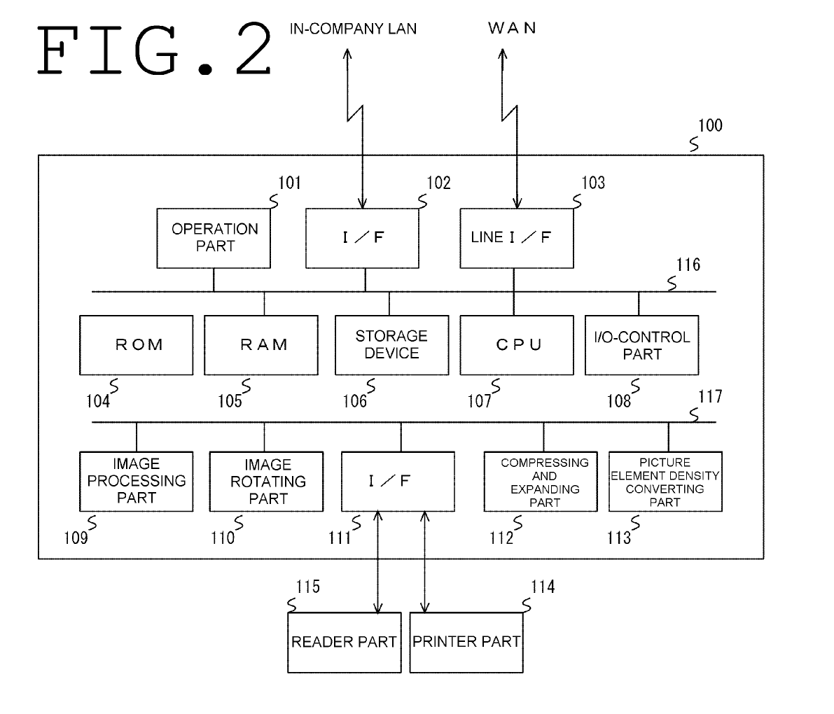

Then, the control system of MFP 100 is explained with reference to FIG. 2. In the control system of MFP 100, a case is mainly shown that programs, such as a print and a scan, are controlled. Also, the control system of MFP 100 controls the program of a management system. The program of the management system manages signal from a sensor that detects remaining toner amount or a sensor that detects replacement of toner, or the like. For example, when detecting a toner container is replaced, MFP 100 issues event information and transmits it to managing server 400.

Also, the control system has a part that performs a system management, and a part that performs image-processing management. The part that performs a system management includes operation part 101, I/F (interface) 102, line I/F 103, ROM (Read Only Memory) 104, RAM (Random Access Memory) 105, storage device 106, CPU (Central Processing Unit) 107. Also, the part that performs image-processing management includes I/O-control part 108, image processing part 109, image rotating part 110, I/F 111, compressing and expanding part 112, and picture element density converting part 113. Then, these parts are connected with system bus 116 and image bus 117.

The following components are arranged in system bus 116. In operation part 101, a display part and a key input part, such as a touch panel, are built in, and CPU 107 controls. A user makes various setup instructions about scanner reading or printout, and an operation/stop instruction by the key input part. Also, user can confirm residual quantity, toner container identification information, or the like, in the loaded toner container by operation part 101.

I/F 102 is a circuit including the interface for connecting with in-company LAN 10. I/F 102 communicates with managing server 400 via in-company LAN 10. For example, MFP 100 transmits the monitoring information to managing server 400 via I/F 102 by using various protocols.

Line I/F 103 is a circuit that is connected to a network and performs transmission and reception of data with a remote terminal. Line I/F 103 is controlled by a communication control program and performs data transmission and reception.

CPU 107 executes a control program of MFP 100 memorized in ROM 104 and storage device 106 and the monitoring program about monitoring control. RAM 105 is a work memory for executing the programs. CPU 107 reads the various programs memorized in ROM 104 to RAM 105, analyzes them, and executes various types of processing. RAM 105 temporarily stores status information needed when the monitoring program for monitoring MFP 100 manages device information and image data received from I/F 102. Storage device 106 is a nonvolatile storage. Storage device 106 memorizes various operational mode setups, a counter value, status information, or the like, for MFP 100. The various operational mode setups can be kept after a reboot. Counter values are printing number of sheets for each size and number-of-times of manuscript reading, or the like. Status information includes a status flag. In the setup information memorized in storage device 106, the residual quantity information and toner container identification information in the loaded toner container are also included. In addition, the operating system of MFP 100, other application programs, or the like are memorized.

By executing a control program, CPU 107 executes the process of a copy, a print, or the like, which a user instructs. Also, a monitoring program executed by CPU 107 reads operation information and fault information, such as a counter value and an operation log in storage device 106. By the monitoring program, these are transmitted to managing server 400 via I/F 102 as status information of MFP 100.

Monitoring information also includes operation information and fault information. Operation information shows information of a counter value, a log, or the like, which is generated in case of performing the normal operation. Also, fault information shows information of jam, an error, or the like, in case that it becomes impossible to execute the process. MFP 100, CPU 107 executes a monitoring program. Thereby, when replacement of a toner container is performed, it transmits to managing server 400 as event information that the toner container is replaced. When MFP 100 transmits event information, it reads from storage device 106 the residual quantity of the toner container loaded before replacement. Thereby, MFP 100 checks whether it is removed in the middle or the last to be used. Also, MFP 100 confirms the toner container identification information, the present counter information, or the like in newly loaded toner container. MFP 100 sets these as format of the event information to transmit and transmits it.

In addition, it may be included illegally copied information in toner container identification information. The toner container identification information, which is illegally copied, is determined by the managing server 400 side. Also, there is a case that it may be an unknown toner container identification information. In this case, it is supposed that toner container identification information discrimination is impossible. The “toner container identification information discrimination is impossible” are contents that shows the unknown identification information of the toner container. In addition, the unknown identification information of a toner container is identification information, or the like, which are given to the third party's toner container (product of other company.)

That is, it is not fit to the managed identification information. Also, when the identification information of the toner container is not indistinct or the identification information itself is not expressed, the identification information becomes unknown.

I/O-control part 108 is a circuit including a bus bridge for connecting system bus 116 with image bus 117 to transmit image data at high speed. Image bus 117 is configured of various data buses. The following components are arranged on image bus 117. I/F 111 is a circuit including the interface that connects reader part 115, printer part 114, and the control system of MFP 100. I/F 111 converts either of synchronizing systems and asynchronously system for image data. Also, information detected by the above-mentioned various sensors arranged to places in reader part 115 or printer part 114 is output to system bus 116 via I/F 111 and I/O-control part 108. Image processing part 109 is a circuit that performs compensating, processing, and editing for an input image data and an output image data. Image rotating part 110 is a circuit to rotate an image data. Compressing and expanding part 112 is a circuit that performs a compressing and extending process of multi value image data. Compressing and expanding part 112 is a circuit that converts JPEG and binary image data to JBIG, MMR, MR, MH, or the like. Picture element density converter 113 is a circuit that performs definition conversion, or the like, for the image data for an output.

<The Software Module Configuration of MFP 100>

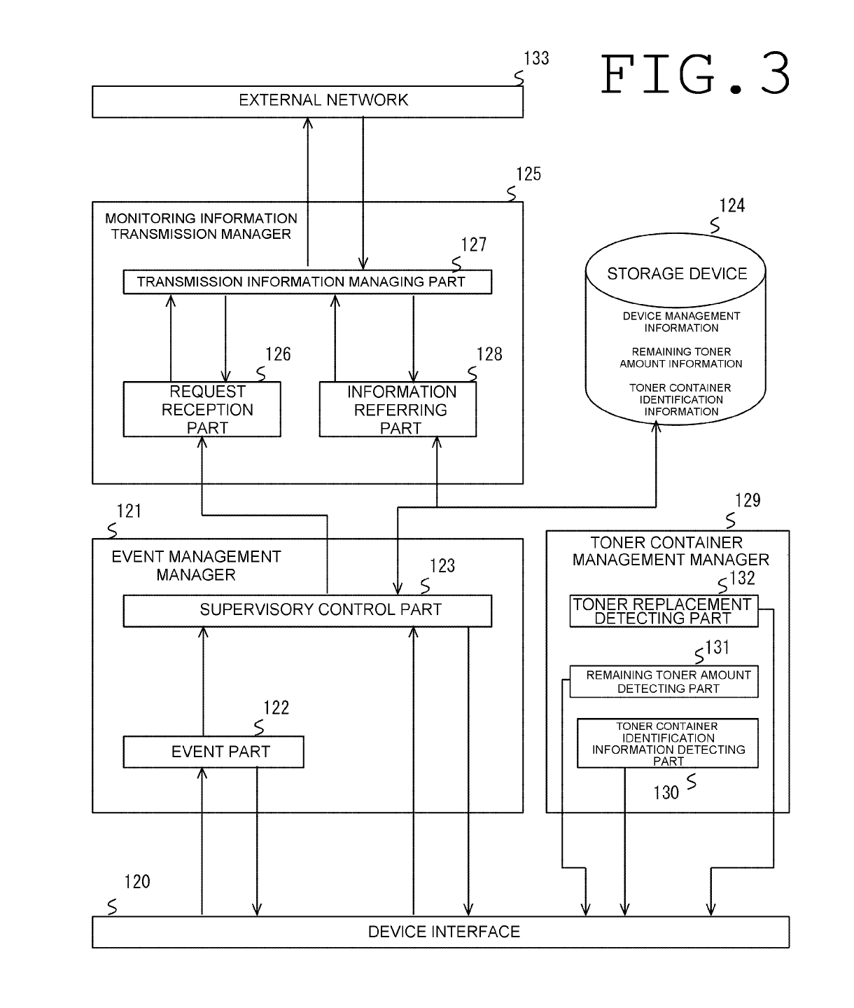

Then, with reference to FIG. 3, the configuration of the monitoring program module in MFP 100 that can be communicated with an external system is explained. In the following, the event transmission process of toner container replacement is explained. Also, numerals 120-132 in FIG. 3 show each monitoring program module in MFP 100. When CPU 107 in MFP 100 executes these program modules, the process explained in the following is realized.

The monitoring program module includes device interface 120, event management manager 121, storage device 124, and monitoring information transmission manager 125. Device interface 120 is equivalent to I/O-control part 108 in FIG. 2. Event management manager 121 manages event information in response to the event that occurs in MFP 100. Storage device 124 memorizes management information needed for management of MFP 100. Storage device 124 is nonvolatile memory, such as storage device 106 and ROM 104 in FIG. 2. Also, monitoring information transmission manager 125 transmits the event information occurred in MFP 100 to remote managing server 400. Toner container management manager 129 provides the management information of a toner container loaded in MFP 100 to device interface 120.

Toner container management manager 129 has toner container identification information detecting part 130, remaining toner amount detecting part 131, and toner replacement detecting part 132. After replacement of the toner container is performed, toner container identification information detecting part 130 acquires the toner container identification information with that it was loaded newly, and provides event management manager 121 with it via device interface 120. That is, toner container identification information detecting part 130, when replacing a toner container, functions as a detecting part that detects the toner container identification information of newly loaded toner container.

Remaining toner amount detecting part 131 detects how much toner remains in the loaded toner container and provides with the residual quantity information in a toner container to event management manager 121 via device interface 120. The residual quantity information in a toner container is the information whether residual quantity remains or not may be sufficient. Also, the residual quantity information may be sufficient information of the exact toner remaining capacity in the toner container. In this case, the information of the percentage of toner remains in the toner container may be allowable as the residual quantity information. Thus, remaining toner amount detecting part 131 functions as a managing part that manages the residual quantity information of the expendable supplies included in the loaded toner container, which is also the expendable supplies. Toner replacement detecting part 132 detects replacement of the toner container, which is, for example, a start and a completion of the toner container replacement, via a sensor and notifies an event to device interface 120.

Event management manager 121 has event part 122 and supervisory control part 123. Event management manager 121 receives various event information detected by toner container management manager 129 via device interface 120. Event management manager 121 records information needed for management of MFP 100 in storage device 124. The event information managed by event management manager 121 includes the event of the issued print job by a user, general status information of MFP 100 including an error, or the like. Event part 122 receives the event of MFP 100 through device interface 120. Supervisory control part 123 receives the event information from event part 122, determines type of event, and decides a subsequent response.

For example, event management manager 121 confirms the residual quantity in a toner container for each issued print job by a user. Then, event management manager 121 performs the writing to storage device 124 as the latest remaining toner amount information in the present MFP 100. Also, one of the events that are handled by event management manager 121 is the error of MFP 100. As the error of MFP 100, a high urgency error, a warning-level error, or the like, are listed. The high urgency error is a hard disk error, a charging counter error, or the like. The warning level error is a sheet jam, a toner low, or the like. Also, similarly, the event information showing replacement of the toner container, or the like, is notified to event management manager 121 via device interface 120.

Event part 122 registers the event information made into a monitoring object within event management manager 121 to device interface 120 when MFP 100 starts. The registered event information may be set up by an administrator or it may be determined, previously. By performing registration process by event part 122, when occurring an event needed for the monitor of MFP 100, a notice is received in real time. Accordingly, when an event, such as an error of the monitoring object or replacement of the toner container, occurs in MFP 100, the event information is received via device interface 120. Also, event part 122 notifies the received event information to supervisory control part 123, immediately.

Supervisory control part 123 receives an event notification from event part 122. Then, supervisory control part 123 requires information needed when notifying various kinds of events to device interface 120 and receives provided information. Supervisory control part 123 memorizes the received related information of the event, which is provided from device interface 120, in storage device 124. Supervisory control part 123 memorizes the event information in storage device 124. Then, supervisory control part 123 issues send request for managing server 400 to monitoring information transmission manager 125.

Storage device 124 is ROM 104 and storage device 106 in FIG. 2. Storage device 124 memorizes device configuration information, such as firmware information and an identification number of an image forming apparatus. Also, storage device 124 memorizes the management information of MFP 100 relevant to the occurred event. Management information is an error code and its generation time, generation time that the event is occurred, or the like. Also, storage device 124 memorizes the following information when the occurred event is a replacement event of a toner container. That is, storage device 124 functions as a managing part. Storage device 124 memorizes residual quantity information of the toner container loaded before replacement, toner container identification information that is newly-loaded, and counter information of MFP 100 at that time, with making associate with the replacement event of the toner container.

Monitoring information transmission manager 125 has request reception part 126, transmission information managing part 127, and information referring part 128. Request reception part 126 accepts a send request from supervisory control part 123 of event management manager 121. Request reception part 126 immediately hands over the send request to transmission information managing part 127 when the event send request is received. Transmission information managing part 127 requests event information from information referring part 128 when the send request of the event information is received from request reception part 126. Information referring part 128 receives the request of event information acquisition from transmission information managing part 127. Then, information referring part 128 gets event information from storage device 124 and returns it as a response of a request to transmission information managing part 127. Transmission information managing part 127 converts the obtained event information into the event information format for transmitting to managing server 400 and transmits to external network 133 as the management information.

<Example of a Configuration of the Control System of Managing Server 400>

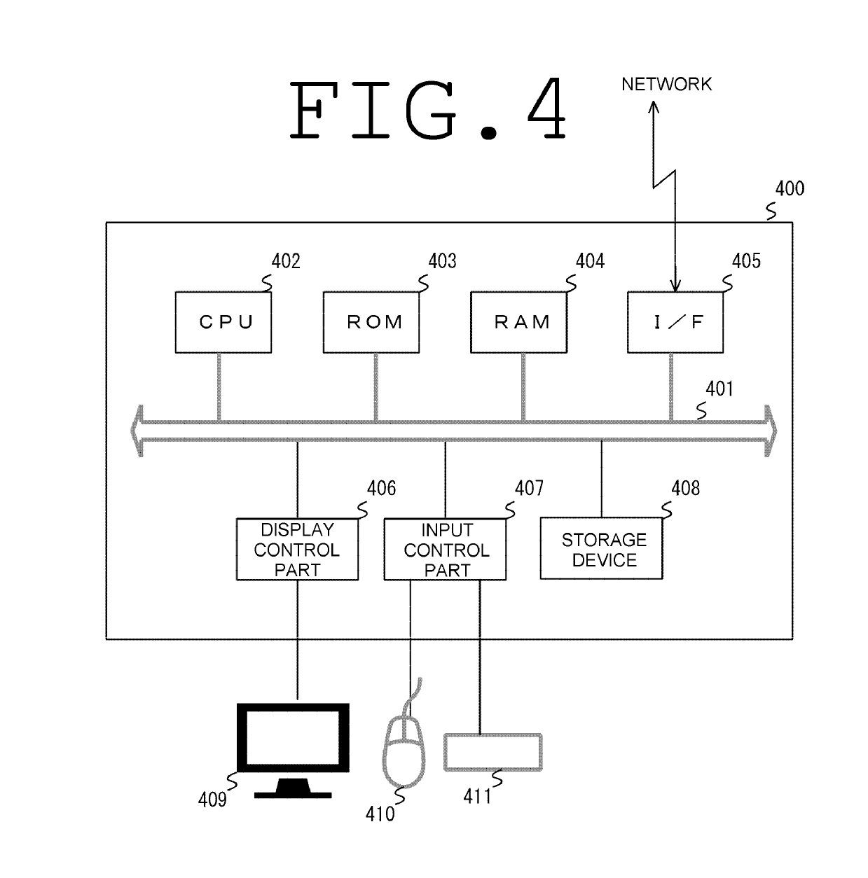

Then, with reference to FIG. 4, an example of a configuration of the control system of managing server 400 is explained. Managing server 400 may be configured as a general-purpose personal computer, or the like. Managing server 400 includes CPU 402, ROM 403, RAM 404, I/F 405, display control part 406, input control part 407, and storage device 408. They are connected to bus 401, and they can transmit and receive data. CPU 402 controls as a whole for managing server 400. ROM 403 is a read-only memory for memorizing a boot program needed for a system startup. RAM 404 is a work memory needed when executing a program by CPU 402. I/F 405 is a circuit including an interface to connect with network and to communicate with other apparatus. Display control part 406 is a circuit that displays maintenance content of MFP 100, or the like, on display 409. Input control part 407 is a circuit that accepts an input via input devices 410 and 411 by an operator who manages managing server 400. Also, managing server 400 is a circuit including storage devices 408, such as a magnetic disk that memorizes a program executed by CPU 402, the maintenance information sent from MFP 100, or the like.

Managing server 400 receives the notice of operation information from MFP 100 at regular intervals via I/F 405 and receives the notice of an abnormal condition at irregular intervals. The abnormal condition is in a state when a failure occurs in MFP 100 and it becomes impossible to perform the normal process, such as showing a state under jam or error generation. The operation information notified at regular intervals from MFP 100 includes counter value used for copying or printing, component counter value for measuring the lifetime of a consumable part, in addition, an operation log, or the like. Managing server 400 computes a periodic maintenance cost to be charged every month for a user who owns MFP 100 based on the operating information. Also, a degree of exhausting for a currently-used part in MFP 100 within a recommendation lifetime is output in a form of a report. Managing server 400 serially memorizes the operation information in storage device 408. On the other hand, the operator who manages managing server 400 determines the amount billed to a user with referencing the memorized operation information, suitably.

Information showing the abnormal condition of MFP 100 notified at irregular intervals includes an error/alarm information, such as an occurred hard failure, jam, or the like, in addition to the operation information. Managing server 400 determines for a process based on the urgency of information when the information is received. For example, when the fault information that needs to correspond immediately, such as a service call error of MFP 100, is received, an e-mail is transmitted to a serviceman who manages for the target MFP 100. Further, by memorizing serially in storage device 408 and by displaying on display 409, an operator is notified that MFP 100 having fallen into the abnormal condition. Also, managing server 400, when urgency is low as like jam or alarm, serially memorizes the received information in storage device 408. Then, managing server 400 determines whether or not it is necessary to display on display 409 whether transmission of an e-mail is needed or not. On the other hand, the operator determines the state of MFP 100 by the contents of a display on display 409 and instructs fault restoration operations to a serviceman if needed. Also, expendable supplies, such as a toner, are sent to the customer.

The irregularly-notified information of MFP 100 also includes the event information showing replacement of the toner container or the like, and the notice for performing toner management. Managing server 400 receives the event information of replacement of the toner container from MFP 100. Then, managing server 400 refers to the management information of the toner container that has been sent to the customer. Managing server 400 performs matching toner container identification information with the newly loaded toner container identification information. The newly loaded toner container identification information is included in event information. For this reason, managing server 400 can be matched them. Thereby, managing server 400 can check which toner has been newly used among the toners sent to the customer. Also, as mentioned above, even if toner container identification information, or the like, is copied illegally, or toner container identification information is unknown, it matches by receiving the event information of replacement of the toner container from MFP 100. Thereby, it can be confirmed being used as intermingled with a shipped (genuine) toner.

Also, managing server 400 acquires the residual quantity information in the toner container, which is loaded before replacement, from the event information of replacement of the toner container. Managing server 400 determines from this information that the toner container loaded before replacement is removed in the middle of use, or is removed as finished to use at all. Also, the counter information of MFP 100 at the time of replacement is obtained from the event information of replacement of the toner container and it adds to the toner management information in managing server 400. By above-mentioned process, managing server 400 computes the number of printings used by the toner container loaded before replacement. Managing server 400 manages that the toner is efficiently used in the user side by using these pieces of information.

<An Example of a Configuration of Software of Managing Server 400>

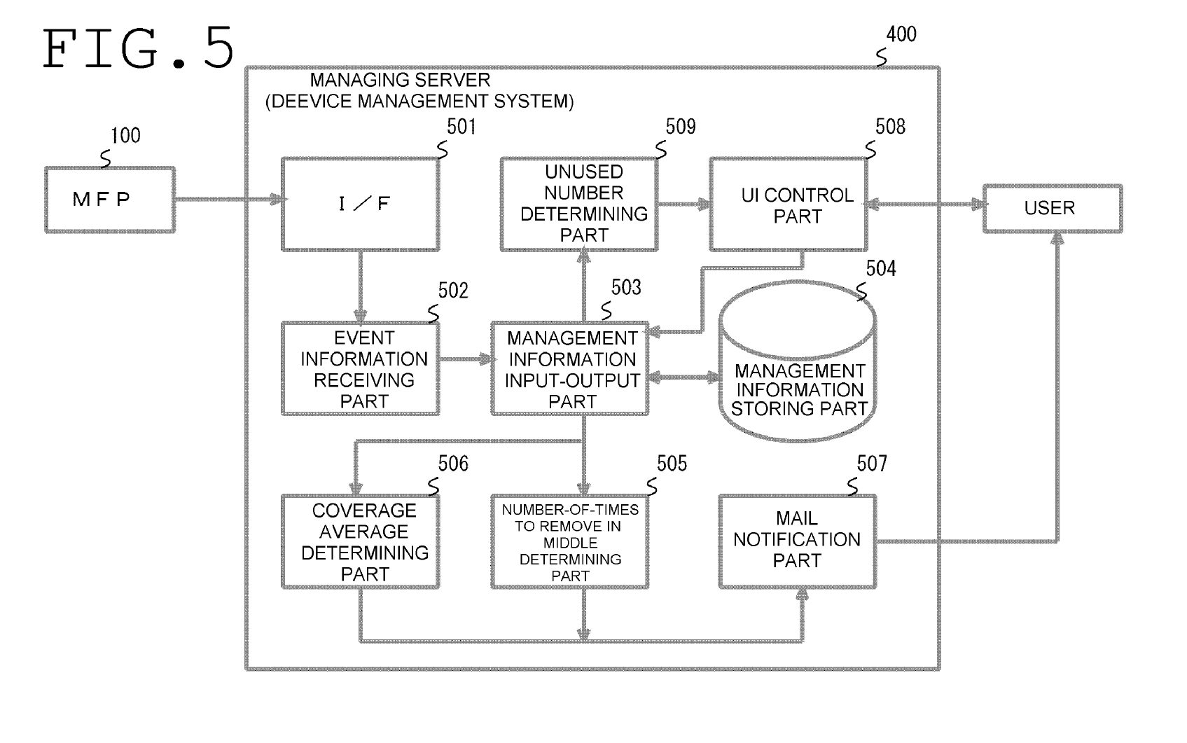

Then, with reference to FIG. 5, the example of a configuration of managing server 400 is explained. CPU 402 (as refer to FIG. 4) in managing server 400 executes a monitor program memorized in ROM 403 and storage device 408. Thereby, CPU 402 works as I/F 501, event information receiving part 502, management information input-output part 503, management information storing part 504, number-of-times to remove in middle determining part 505, coverage average determining part 506, mail notification part 507, UI control part 508, and unused number determining part 509. In detail, CPU 402 of a managing server executes a monitor program. Thereby, I/F 405 (as refer to FIG. 4) works as I/F 501. Also, CPU 402 works as event information receiving part 502, management information input-output part 503, number-of-times to remove in middle determining part 505, and coverage average determining part 506. Also, storage device 408 (as refer to FIG. 4) works as management information storing part 504.

I/F 501 receives monitoring information from MFP 100. Especially, in the present embodiment, the event information about toner management is described. Event information receiving part 502 receives the notice of replacement and receives the event information that expresses replacement of the toner container from I/F 501. Management information input-output part 503 associates the information included in the event information of replacement of the toner container received in event information receiving part 502 and memorizes in management information storing part 504. In detail, management information input-output part 503 associates the toner container identification information, the counter information related to replacement of the toner container, and the residual quantity information of the toner container removed by replacement. Management information input-output part 503 memorizes this associated information in management information storing part 504 as management information. Also, management information input-output part 503 accepts the request of a user's toner use condition from an operator, or the like, via UI control part 508, as described later. Then, management information input-output part 503 acquires the use condition of the toner for a corresponding customer from management information storing part 504. Management information storing part 504 memorizes the toner management information in ROM 403 and storage device 408 as shown in FIG. 4.

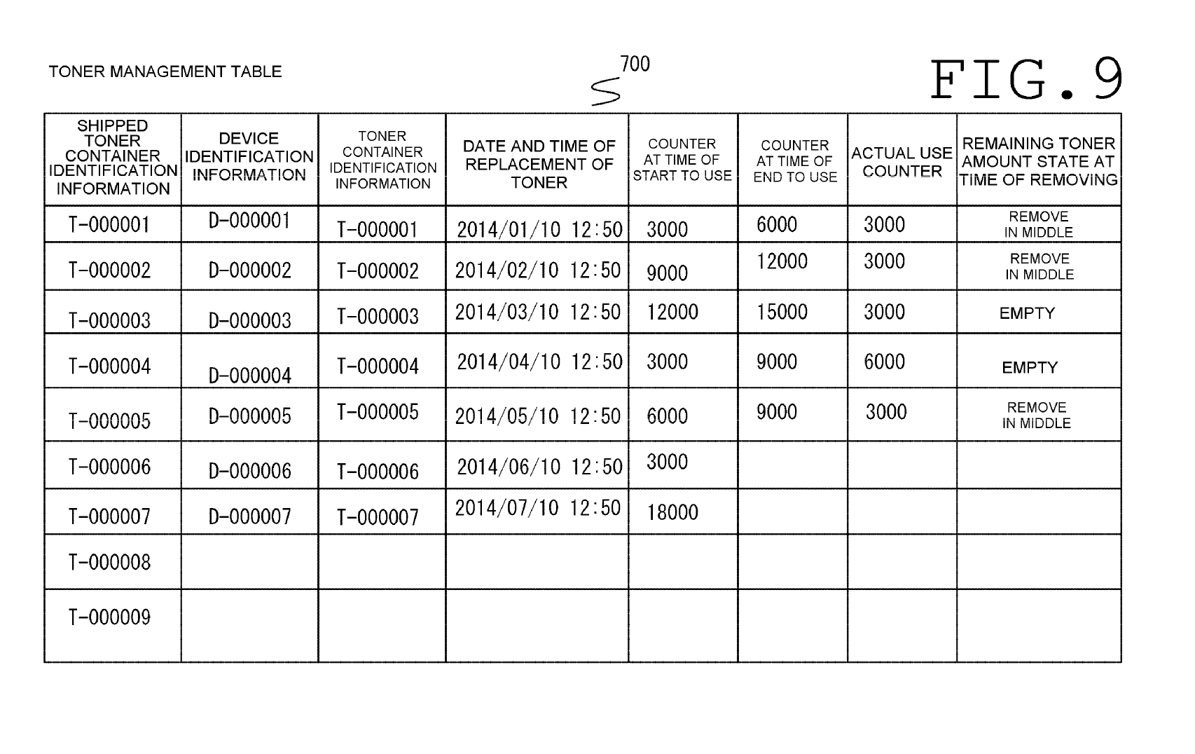

Also, management information input-output part 503 compares toner container identification information 609 included in the event information from MFP 100 and after-mentioned toner management table 700 as shown in FIG. 9 managed by management information storing part 504. Management information input-output part 503 can be checked that the shipped (genuine) toner container has been used if toner container identification information 609 included in event information matches with after-mentioned shipped toner container identification information as shown in FIG. 9. However, when the toner container corresponding to the shipped toner container identification information is used, it can confirm that toner container identification information 609 included in the event information is copied. “Used” is, for example, a case where the remaining toner amount is empty. Also, if toner container identification information 609 included in the event information does not correspond to the shipped toner container identification information, it can confirm to be a third party stuff (product of other company.)

Also, when the identification information of toner container identification information 609 included in event information has contents showing unknown (toner container identification information discrimination is impossible,) it can confirm that it is not at least the shipped toner container.

Number-of-times to remove in middle determining part 505 determines whether or not the number of the toner containers removed in the midst of use in the toner containers, which the user uses, is over a default value. Number-of-times to remove in middle determining part 505 is determined based on the management information of the toner container obtained by management information input-output part 503. Coverage average determining part 506 is, based on the management information of the toner container obtained by management information input-output part 503, average of coverage that shows the printing density of each toner used until that time by user is computed. Coverage average determining part 506 determines whether or not the average of the computed coverage is over a default value.

Mail notification part 507 notifies the operator by using managing server 400 when number-of-times to remove in middle determining part 505 and coverage average determining part 506 determine to over the default value, respectively. Also, mail notification part 507 notices for making the user using MFP 100 recognize that it is over the default value of number-of-times to remove in middle or the default value of the coverage average. Also, mail notification part 507 notices the user using MFP 100 for telling that the toner container that is not genuine is used, or the like. UI control part 508 receives the input/output of toner management information from the operator using managing server 400. UI control part 508 receives the display of a user's toner use condition and the input of the serial number of each toner container that the toner delivery person in charge of the sales company has been delivered to the user.

Unused number determining part 509 compares the serial number of the toner container that the operator of managing server 400 sent to the user with the serial number included in the notice of replacement of the toner container. Unused number determining part 509 determines whether or not the number of the unused toner container is exceeded to a prescribed number. Unused number determining part 509 gives instructions to UI control part 508 when the number of the unused toner container is exceeded to the prescribed number for the toner container sent to the user. Unused number determining part 509 notifies the operator of managing server 400. Thus, mail notification part 507 and UI control part 508 function as an informing part. When the number-of-times to remove in middle and the coverage average are over the default value or when it is determined that the number of the unused toner container is exceeded to the prescribed number, the informing part notifies an operator, or the like.

<An Example of the Event Information Received by Managing Server 400>

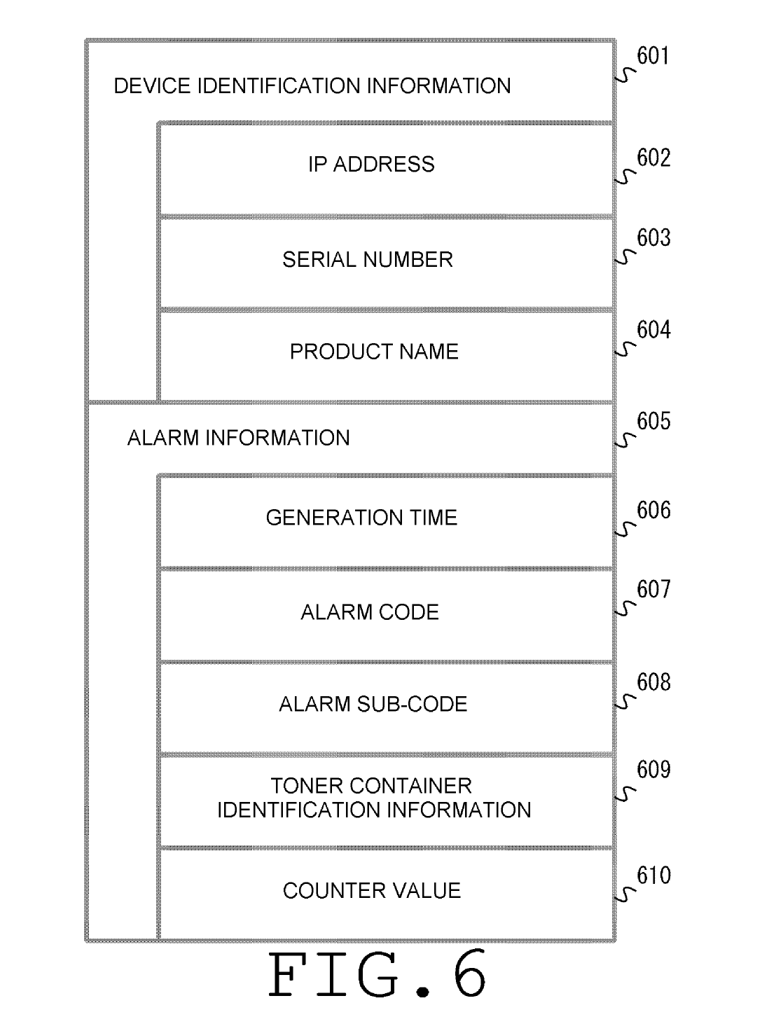

Then, with reference to FIG. 6, an example of the event information that managing server 400 receives is explained. In addition, the event information in FIG. 6 is generated at the timing that a new toner container is loaded to MFP 100. Generation of event information may be performed by MFP 100 or may be performed by base monitoring apparatus 200.

Also, the event information in FIG. 6 is described with description language, for example, and is transmitted to managing server 400 by using an encryption protocol. The event information showing replacement of the toner container is notified to managing server 400 as alarm information of MFP 100. It is defined that the alarm of MFP 100 is not a failure of MFP 100 but the event to be notified or to be recorded. The alarm of MFP 100 is not limited to the replacement of the toner container, and also includes events, such as a “running-out of paper” and an “out of staple.”

These events may be managed in code. For example, a corresponding code is present in the event showing replacement of the toner container.

As shown in FIG. 6, the information included in the event information showing the replacement of the toner container is configured with device identification information 601 and alarm information 605. Device identification information 601 is information for identifying MFP 100. Device identification information 601 includes information such as, for example, IP address 602, serial number 603, product name 604. Alarm information 605 is information showing the contents of the event occurred in MFP 100. Alarm information 605 includes information for generation time 606, alarm code 607, alarm sub-code 608, toner container identification information 609, and counter value 610.

Generation time 606 shows the time detected replacement of a toner container. Generation time 606 may be sufficient the time when the toner container is removed, which is detected by toner replacement detecting part 132 in FIG. 3. Also, generation time 606 may be sufficient the time when the toner container is newly loaded. Alarm code 607 shows the contents of an event occurred in MFP 100, and it means that the replacement event of the toner container is occurred in the present embodiment. Alarm sub-code 608 expresses, as one or more sub-codes, the related information about the replacement of the toner container. Related information is the remaining toner amount information of the toner container before replacement at the time when the toner container is removed by replacing and the information of the color of the toner for replacing, or the like.

Toner container identification information 609 shows the serial number of the toner container loaded to MFP 100. In addition, when the identification information of the toner container is unknown, toner container identification information 609 alternates a serial number to the contents showing that the identification information of the toner container is unknown. These contents are “toner container identification information discrimination is impossible.” Also, counter value 610 shows the total counter value that MFP 100 counted when a toner container is loaded. According to the present embodiment, using tendency of MFP 100 is analyzed after being loaded a toner container until it replaces for a next toner container. For this reason, the total counter that calculates the printing number of sheets output by MFP 100 is used. It is also possible to apply the counter information showing use count of parts, or the like, which can determine the using tendency of MFP 100 besides the total counter. Also, by counter value 610, it can grasp a tendency, similarly. For this reason, the counter information at the time of removing a toner container may be used.

<An Example of Operation of MFP 100>

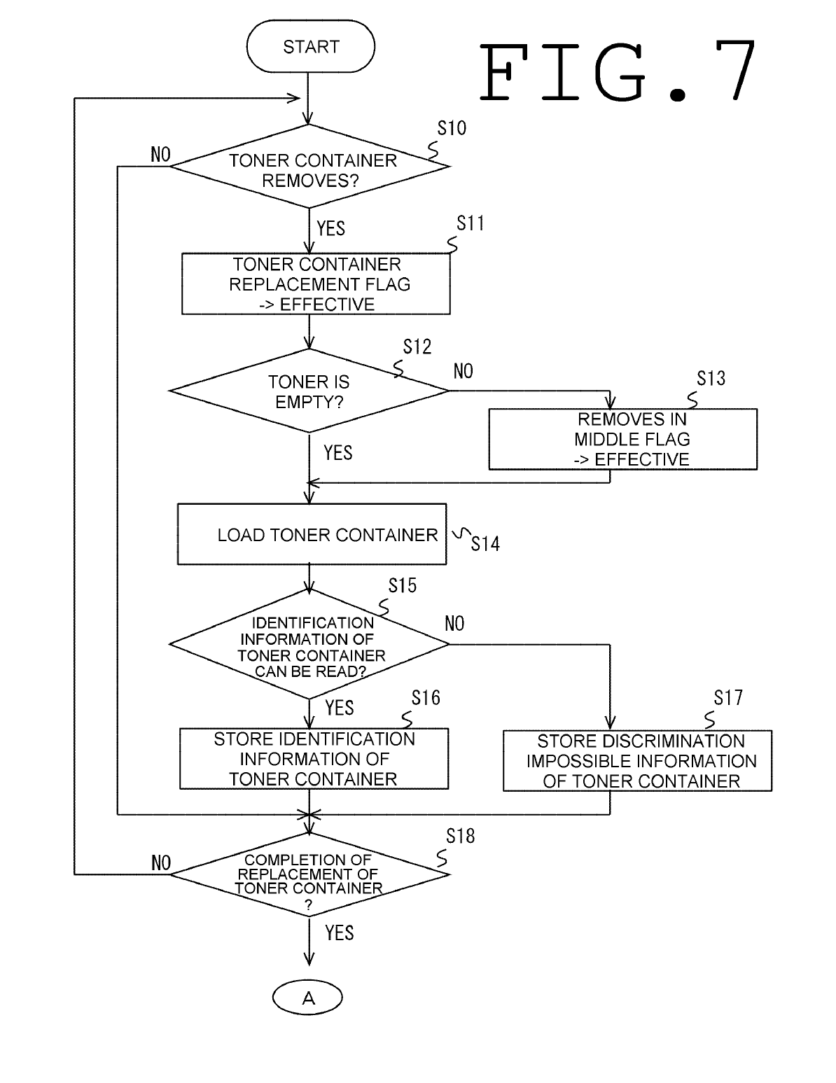

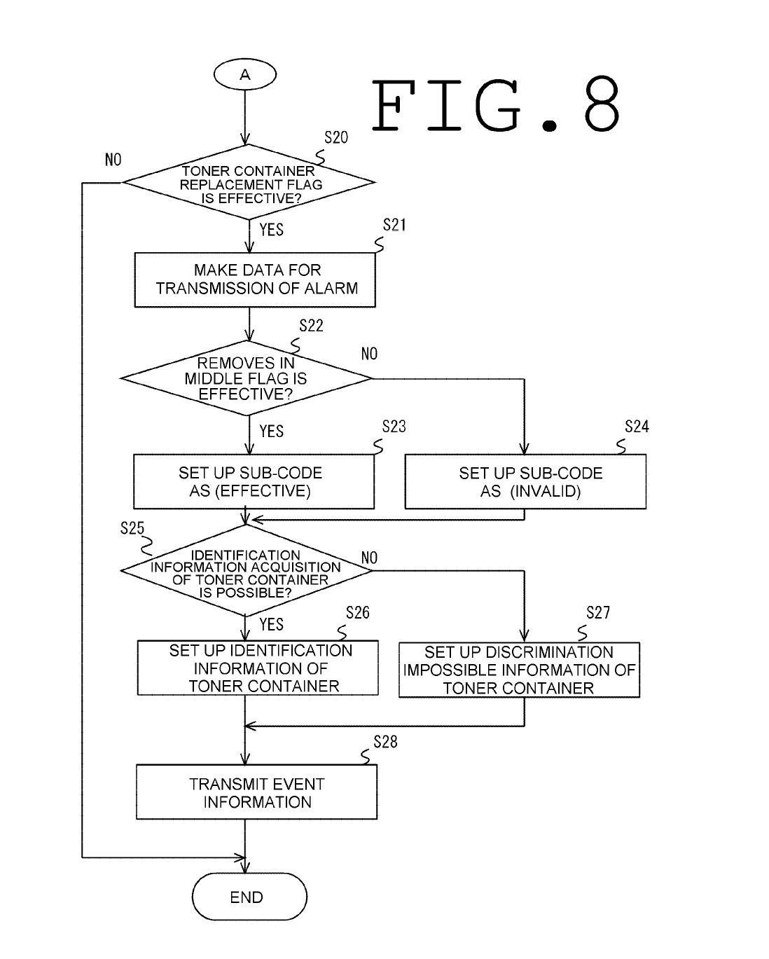

Then, with reference to FIG. 7 and FIG. 8, an operation in the side of MFP 100 is explained. In addition, FIG. 7 and FIG. 8 shows a process, after the user using MFP 100 starts replacement of a toner container, until MFP 100 transmits the notice of replacement of the toner container to managing server 400. This process is realized by CPU 107 executes the program memorized in either memory part of ROM 104 and storage device 106.

Firstly, the door of MFP 100 is opened for toner replacement by the user using MFP 100. At this time, toner replacement detecting part 132 of toner container management manager 129 shown in FIG. 3 detects removing the toner container (Step S10: YES). Toner replacement detecting part 132 notifies event information to device interface 120. Also, although the user open the door of MFP 100, the toner container is not removed (Step S10: NO), it progresses to Step S18.

Subsequently, when receiving that toner replacement detecting part 132 detects removal of the toner container, event part 122 receives the event notification from device interface 120 and passes it to supervisory control part 123. Supervisory control part 123 validates the replacement flag of the toner container in storage device 124 in response to the event notification (Step S11). In the flag setup, supervisory control part 123 stores in storage device 124 whether the toner of which color is removed for replacing. Thereby, even if the multiple replacing of the toner container is performed, managing server 400 can manage each toner container, accurately.

Subsequently, remaining toner amount detecting part 131 detects remaining toner amount. Then, remaining toner amount detecting part 131 performs an event notification to event part 122 via device interface 120. Supervisory control part 123 in event management manager 121 receives the event notification from event part 122. Supervisory control part 123 determines whether or not the removed toner of the toner container is empty (Step S12). When there is no residual quantity in the toner container before replacement (Step S12: YES), it progress to Step S14. Also, when the toner container before replacement has residual quantity, it progresses to Step S13. In Step S13, supervisory control part 123 in event management manager 121, a removing in the middle flag is effectively set in storage device 124 and is memorized in it. In this case, supervisory control part 123 is associated with the information of the removed toner container.

On the other hand, in Step S14, toner replacement detecting part 132 detects the toner container having been loaded and progresses to Step S15. In Step S15, toner container identification information detecting part 130 in MFP 100 determines whether toner container identification information written in newly loaded toner container can be read or not. Toner container identification information is attached to the toner container in a form, such as a bar code and IC, and it is read by a sensor. Toner container identification information detecting part 130, if it is not able to read well by dirt of the bar code or out of order of IC (Step S15: NO), progresses to Step S17. Also, toner container identification information detecting part 130, if toner container identification information is able to be read satisfactorily (Step S15: YES), it progresses to Step S16. In Step S16, supervisory control part 123 receives the toner container identification information that toner container identification information detecting part 130 acquired via event part 122, memorizes it in storage device 124, and it progress to Step S18.

On the other hand, if toner container identification information detecting part 130 is not able to read toner container identification information, supervisory control part 123 stores in storage device 124 the flag that shows toner container identification information discrimination being impossible, and it progresses to Step S18. At Step S18, toner replacement detecting part 132 in toner container management manager 129 detects completion of replacement of the toner container and close of the door. When supervisory control part 123 receives an event notification from event part 122 and determines it as the completion of replacement of the toner container (Step S18: YES), it progresses to Step S20 of FIG. 8. In addition, if the door is not closed, and replacement of other toner containers starts (Step S18: NO), it progresses to Step S10. Thereby, a process of other toner container replacement is performed.

In Step S20 of FIG. 8, supervisory control part 123 confirms whether the flag of the toner container replacement is effective to storage device 124. Supervisory control part 123, if the flag of toner container replacement is not effective (Step S20: NO), the issue process of the notice of toner container replacement is ended. That is, although the user opens the door to replace toner containers, and the toner container is not removed and is not replaced, supervisory control part 123 ends the process. Also, if the flag of toner container replacement in storage device 124 is effective (Step S20: YES), it progresses to Step S21.

In Step S21, request reception part 126 accepts the request of event information transmission of the replacement of the toner container from supervisory control part 123 and hands a send request to transmission information managing part 127. Transmission information managing part 127 starts making of the data for transmission to transmit the replacement event information of the toner container. That is, data setting for transmission of the alarm code showing that the toner container replacement event is occurred to alarm code 607 as shown in FIG. 6. Then, it progresses to Step S22.

In Step S22, information referring part 128 accesses storage device 124 in response to the management information request from transmission information managing part 127 and confirms whether the removing in the middle flag is effective or not. If the removing in the middle flag is effective (Step S22: YES), it is indicated that, at the time of replacing the toner container, the toner container has been removed in the state where the toner still remains. If the removing in the middle flag is effective, information referring part 128 progresses to Step S23. Also, if the removing in the middle flag is not effective (Step S22: NO), supervisory control part 123 progresses to Step S24.

In Step S23, transmission information managing part 127 determines a sub-code in response to a request response from information referring part 128. That is, transmission information managing part 127 determines the color of the toner for replacing target. Also, transmission information managing part 127 determines sub-code of alarm that indicates the toner container having been removed in the state where the toner still remains. Then, transmission information managing part 127 sets the determined sub-code as the data for transmission. On the other hand, in Step S24, transmission information managing part 127 determines the corresponding sub-code of alarm by the color of the toner serving as the replacing target and the information the residual quantity being empty in the toner container before replacement. Transmission information managing part 127 sets it as the data for transmission of alarm and progresses to Step S25.

In Step S25, information referring part 128 receives the management information request from transmission information managing part 127 and determines whether or not the toner container identification information is memorized in storage device 124. If toner container identification information is memorized (Step S25: YES), information referring part 128 progresses to Step S26. Also, if toner replacement detecting part 132 cannot obtain the toner container identification information, and the identification information is not memorized in storage device 124 (Step S25: NO), information referring part 128 progresses to Step S27.

In Step S26, transmission information managing part 127 receives a request response from information referring part 128, sets the toner container identification information that shows toner container identification information as the data for transmission of alarm, and progresses to Step S28. On the other hand, in Step S27, transmission information managing part 127 sets the information that shows that toner container identification information is not able to be acquired as the data for transmission of alarm, and progresses to Step S28. The information that shows that toner container identification information is not able to be acquired may be set to toner container identification information 609 as an error, and it may be a configuration that sets to alarm sub-code 608.

In Step S28, transmission information managing part 127 transmits a management information request to information referring part 128 and receives a total count value from information referring part 128. The total count value is the printing number of sheets counted by MFP 100 at the time of the replacement of the toner container. Transmission information managing part 127 sets up counter value 610 that shows the received counter information to the made data for transmission of the alarm and transmits event information to managing server 400. MFP 100, when the transmission is completed, ends the transmission process of the event information showing the toner container replacement. Thus, transmission information managing part 127 functions as a transmitting part that transmits the notice of replacement to managing server 400. The notice of replacement includes the detected identification information, the counter information, and the residual quantity information of expendable supplies included in the toner container of the expendable supplies loaded last time and is removed by replacement. In above-mentioned process, transmission information managing part 127 transmits the request to information referring part 128 for every request and makes the data for send alarms. For a matter of course, transmission information managing part 127 may be a configuration that requests needed in order to make the data for send alarms are required to information referring part 128, collectively.

<An Example of Toner Management Table 700 in Managing Server 400>

Then, with reference to FIG. 9, for managing server 400, in DB, which management information storing part 504 shown in FIG. 5 manages, toner management information for a user is explained. Toner management table 700 is composed from a plurality of tables in the relational database, for example. Toner management table 700 shown in FIG. 9 includes shipped toner container identification information, device identification information, toner container identification information, date and time of replacement of toner container, a counter at the time of start to use, a counter at the time of end to use, actual use counter, and a field memorizing a remaining toner amount state at the time of removing. The counter at the time of start to use, the counter at the time of end to use, and the actual use counter are the counter information that shows the system operating status of MFP 100.

Shipped toner container identification information is the field that memorizes the toner container identification information sent from the sales company to the user. When the toner delivery person in charge of the sales company sends a toner for a customer, by using input device 410, 411 shown in FIG. 4, the serial number of each toner container is input to this field. The serial number may be automatically input by using apparatus, such as a bar code reader and IC scanner.

The device identification information of toner management table 700 is the identification information of MFP 100 serving as the candidate for a maintenance. When toner container replacement alarm is received, management information input-output part 503 shown in FIG. 5 adds suitable data to toner management table 700 with reference to device identification information 601 in the alarm. The toner container identification information of toner management table 700 is toner container identification information newly loaded on MFP 100 when a toner container is replaced in MFP 100 serving as the candidate for the maintenance. Management information input-output part 503 add suitable data to toner management table 700 with reference to toner container identification information 609 in the alarm when the toner container replacement alarm is received.

The date and time of replacement of toner in toner management table 700 is the time at the toner container replacement is performed in MFP 100 serving as the candidate for the maintenance. Management information input-output part 503 adds suitable data to toner management table 700 with reference to alarm code 607 in the alarm when the toner container replacement alarm is received. The counter at the time of start to use in toner management table 700 is, at the time the toner container replacement is performed in MFP 100 serving as the candidate for the maintenance, a counter value in MFP 100 when it is loaded as a new toner and a toner is started to use. Management information input-output part 503 adds suitable data to toner management table 700 with reference to counter value 610 in the alarm when the toner container replacement alarm is received. The counter at the time of end to use date in toner management table 700, at the time the toner container replacement is performed in MFP 100 serving as the candidate for the maintenance, a counter value in MFP 100 when the replaced toner is ended to use. Management information input-output part 503 adds suitable data to toner management table 700 with reference to generation time 606 in the alarm when the toner container replacement alarm is received.

The actual use counter on toner management table 700 is the counter information in which one toner container is concerned. That is, the actual use counter is a counter value showing use number of sheets after the target toner container is loaded in MFP 100 and until it is removed. The counter value can be obtained by management information input-output part 503 by computing difference from a counter at the time of end to use to a counter at the time of start to use. The remaining toner amount state at the time of removing in toner management table 700 is a residual quantity state when toner container replacement is performed in MFP 100 serving as the candidate for the maintenance. The remaining toner amount state at the time of removing shows either there is residual quantity when the toner container before replacement is removed and thus the toner container is removed in the middle of use, or residual quantity is already empty and the toner container becomes empty and is removed. When toner container replacement alarm is received, management information input-output part 503 acquires the residual quantity state in the toner container with reference to the sub-code in the alarm and adds suitable data to toner management table 700.

The Toner container replacement alarm includes both information of the toner container removed from MFP 100 and information of the newly loaded toner container in MFP 100.

The information of the toner container removed from MFP 100 is the information of the residual quantity information of the toner container, the counter value, and the color of the toner of the replacing target. Here, it is the information of the toner container removed by replacement and is written in alarm sub-code 608 in FIG. 6. Management information input-output part 503 acquires serial number 603 that is the identification information of MFP 100 from toner container replacement alarm. Management information input-output part 503 specifies the record of toner management table 700 that has the same serial number as acquired serial number 603. On the specified record, based on the above-mentioned information, the residual quantity information of the toner container removed by replacement last time and the counter value at the time of the end to use are added. Then, management information input-output part 503 computes the difference from the counter value at the time of the end to use to the counter value at the time of start to use. Thereby, management information input-output part 503 acquires the actual use counter value and adds it to the target record.

The information of the newly loaded toner container in MFP 100 is toner container identification information 609 shown in FIG. 6 and counter value 610. Management information input-output part 503 receives the notice of toner container replacement. Management information input-output part 503 searches the newly loaded toner container ID in MFP 100 from the list of the shipped toner container identification information in toner management table 700. When toner container identification information 609 and the searched toner container identification information is matched, management information input-output part 503 adds them to the same record. Here, management information input-output part 503 adds received device identification information, toner container identification information, date and time of replacement of the toner, and the counter at the time of start to use.

On the other hand, although toner container identification information matched, there is a history already used at last time, and the remaining toner amount state is removed in the middle at last time at the time of toner container removing, a new record is made and the same information is added. Thereby, by managing as like these, three subjects, the total of the unused toner container being shipped to a user, the total of the toner containers being shipped to the customer but being removed in the middle and being not used to the last, and the using tendency of each toner can be confirmed. Also, as above-mentioned, even if the toner container identification information, or the like, is copied illegally or it is unknown toner container identification information, it can be matched by receiving the event information of replacement of the toner container from MFP 100. Thereby, it can be confirmed intermingle-use with a shipped (genuine) toner.

<An Operation Example of Managing Server 400>

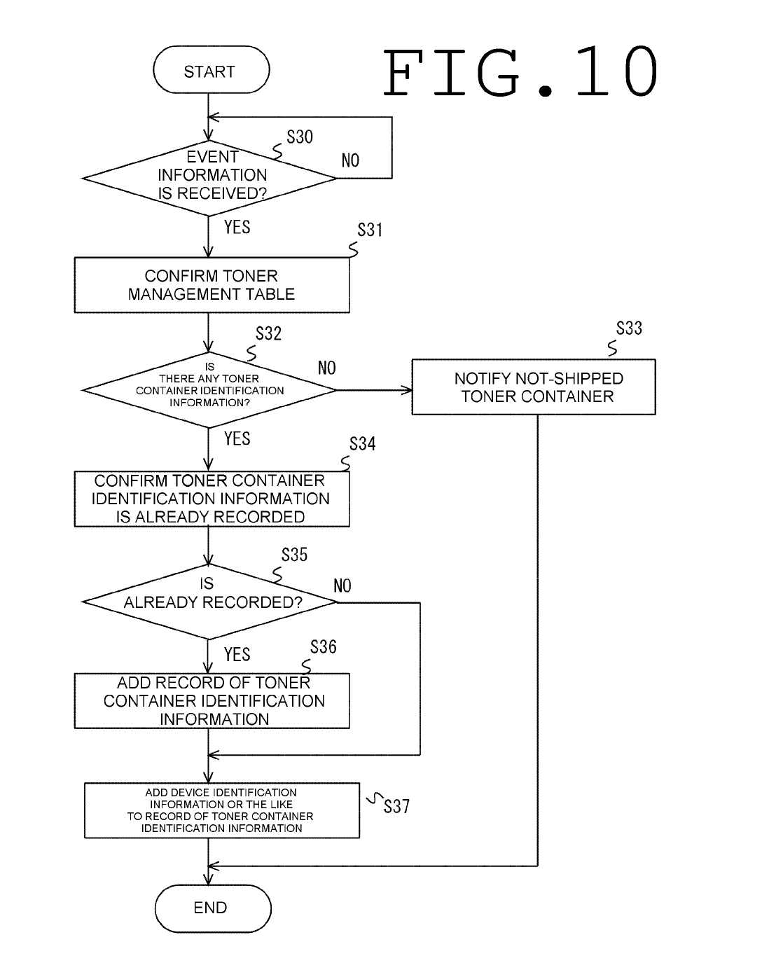

Then, with reference to FIG. 10, the operation by the side of managing server 400 is explained. FIG. 10 shows the process that managing server 400 receives the event information about replacement of the toner from MFP 100 and updates toner management table 700. In this case, managing server 400 checks whether replacing with the shipped (genuine) toner container. This process is realized by CPU 402 expanding a program memorized in either memory part, ROM 403 or storage devices 408 as shown in FIG. 4, to RAM 404 and executing it as needed. Also, this process is carried out by event information receiving part 502, management information input-output part 503, management information storing part 504, mail notification part 507, or the like, which are shown in FIG. 5.

First, event information receiving part 502 of managing server 400 becomes the reception waiting of the event information transmitted from MFP 100 at the time of the toner container replacement (Step S30: NO). Event information receiving part 502, when the event information is received (Step S30: YES), it progresses to Step S31. In Step S31, management information input-output part 503 acquires toner container identification information 609 by the event information received from MFP 100. Management information input-output part 503 confirms whether or not there is the matched toner container identification information 609 in the shipped toner container identification information in toner management table 700. Management information input-output part 503, if there is the toner container identification information (Step S32: YES), it progresses to Step S34. Also, if there is no received toner container identification information (Step S32: NO), it progresses to Step S33.

In addition, in Step S32, management information input-output part 503 determines whether the toner container that must not have been shipped is used in the user side. That is, if the toner container identification information 609 is matched with the shipped toner container identification information, it can be determined that it is a shipped toner container. However, if the toner container corresponding to the shipped toner container identification information already serves as used, toner container identification information 609 included in the event information can be determined as being copied. In addition, whether or not the toner container is already used can be determined, for example, by the remaining toner amount is empty or not. Also, if toner container identification information 609 included in the event information does not correspond to the shipped toner container identification information, it can be determined that it is a third party product (product of other company.) Also, if the identification information of toner container identification information 609 included in the event information is contents showing unknown (toner container identification information discrimination is impossible,) it can be determined that it is not at least a shipped (genuine) toner container.

In this case, in Step S33, mail notification part 507, to MFP 100 side, the notice for telling that not shipped (genuine) toner container is used, or the like, is performed. Also, management information input-output part 503 performs the notice for telling that not shipped (genuine) toner container is used, or the like, to a user of managing server 400 and ends the process. By this notice, the user of managing server 400 can confirm that the not shipped (genuine) toner container is used. Also, the user using MFP 100 can also confirm that not shipped (genuine) toner container is used. Then, the process is ended.

At Step S34, management information input-output part 503 confirms whether or not the received toner container identification information is already recorded in toner management table 700. This is because if it is removing in the middle at the time of last toner removing, the target record has become already being recorded. Here, management information input-output part 503 detects the target toner container identification information in the list of shipped toner container identification information. Management information input-output part 503 further confirms whether or not the record of the toner container identification information is already recorded. If it is already recorded (Step S35: YES), it progresses to Step S36. If it is not recorded (Step S35: NO), it progresses to Step S37.

In Step S36, management information input-output part 503 adds, to the shipped toner container identification information in toner management table 700, the record of the same toner container identification information, again. Then, it progresses to Step S37. In Step S37, management information input-output part 503 adds to the shipped toner container identification information in toner management table 700. In this case, management information input-output part 503 adds the device identification information and the toner container identification information to the non-input record of the toner container identification information included in the received alarm. Also, management information input-output part 503 adds the date and time of replacement of the toner and the counter at the time of start to use, and the process is ended. That is, management information input-output part 503, if the record of the toner container identification information included in the event information is not already recorded, as the management information corresponding to the newly loaded toner container, memorizes the device identification information, the toner container identification information, and the counter at the time of start to use.

In this way, in the present embodiment, an image forming apparatus (MFP 100) is provided with a detecting part (toner container identification information detecting part 130) that detects the identification information of a container (toner container) with replacement of the container (toner container) of expendable supplies (toner). Also, image forming apparatus (MFP 100) is provided with a transmitting part (monitoring information transmission manager 125) that transmits event information including the detected identification information to a control apparatus (managing server 400). The control apparatus (managing server 400) is provided with a receiving part (event information receiving part 502) that receives event information. Also, control apparatus (managing server 400) is provided with an identification information determining part (management information input-output part 503). The identification information determining part (management information input-output part 503) compares the identification information of the container (toner container) included in the received event information, and a management table (toner management table 700) that manages shipped expendable supplies. Also, identification information determining part (management information input-output part 503) determines whether the identification information of a container (toner container) corresponds to be shipped expendable supplies (toner). Also, control apparatus (managing server 400) is provided with an informing part (mail notification part 507). The informing part (mail notification part 507) notifies the contents that show not corresponding to the image forming apparatus (MFP 100), when the identification information of a container (toner container) does not correspond to the shipped expendable supplies (toner).

Here, shipped expendable supplies (toner) are genuine toner that suitable for use of the image forming apparatus (MFP 100). When exchanged for the expendable supplies (toner) except genuine, it can urge confirming of expendable supplies (toner) by notifying the image forming apparatus (MFP 100) side that they are the expendable supplies except genuine. As a result, the expendable supplies (toner) are appropriately manageable so that a trouble in the image forming apparatus (MFP 100) may not happen.

When it explains in detail, in the typical management system mentioned above, it can manage whether or not a toner container is replaced in the middle of use when replacing the toner container. It is possible for thereby to suppress to replace toner containers in the middle of use.

However, in such a management system, identification information of a toner container and identification information of an image forming apparatus are associated and managed. Therefore, when the identification information of a toner container, or the like, is copied illegally, or when a toner having unknown identification information of a toner container intermingled used with a shipped (genuine) toner, management of the toner may not be performed, appropriately.

In addition, the unknown identification information of the toner container means the identification information attached in the third party's toner container (product of other company) is not-applicable to the managed identification information. Also, when the identification information of the toner container is indistinct, or when the identification information itself is not specified, it is considered as the unknown identification information.

As mentioned above, by using other than a shipped (genuine) toner an unexpected trouble may happen to the image forming apparatus. For this reason, it is important to manage a toner, appropriately.

As compared with this, according to the management system, the control apparatus, and the controlling method in the present disclosure, when replacing except for genuine expendable supplies that is suitable use for the image forming apparatus, it is notified to the image forming apparatus side that it is an expendable supplies except for a genuine product. Thereby, it can urge confirming the expendable supplies. Accordingly, expendable supplies are appropriately manageable so that an unexpected trouble to an image forming apparatus may not happen.

In addition, if toner container identification information 609 included in the event information is matched with shipped toner container identification information, it is confirmed that the shipped (genuine) toner container is used. If the toner container corresponding to the shipped toner container identification information is serves as already used (remaining toner amount is empty), it can be determined that toner container identification information 609 included in the event information is copied. If the toner container identification information 609 included in the event information does not correspond to the shipped toner container identification information, it can be determined as a third party's (product of other company). If it is contents (toner container identification information discrimination is impossible) that shows the identification information of toner container identification information 609 included in the event information being unknown, it can be determined as it is not at least a shipped toner container. In any case, if the replaced toner container is not a shipped (genuine) product, it is notified to the image forming apparatus (MFP 100) side that it is the expendable supplies except for a genuine product. Thereby, to avoid an unexpected trouble happened in an image forming apparatus (MFP 100,) it can be managed an expendable supplies (toner,) appropriately.

In addition, the notice to MFP 100 for being expendable supplies other than genuine product is not limited to mail notification part 507 as mentioned above. The function of the remote maintenance that performs remote management may be used via a network, such as the Internet.

Also, according to the present embodiment, MFP 100 is an example of an image forming apparatus, it does not limit to this example. Of course, it may apply to a printer.

What is claimed is:

1. A management system having an image forming apparatus and a control apparatus that manages the image forming apparatus, comprising:
the image forming apparatus includes
a detecting circuit that detects identification information of a container of expendable supplies accompanying replacement of the container, and
a transmitting circuit that transmits event information including detected identification information to the control apparatus; and
the control apparatus includes
a receiving circuit that receives the event information,
an identification information determining circuit that compares the identification information of the container included in received event information and a management table to manage shipped expendable supplies and determines whether the identification information of the container corresponds to the shipped expendable supplies, and
a notice circuit that notifies contents showing not corresponding to the image forming apparatus when the identification information of the container does not correspond to the shipped expendable supplies.

2. The management system according to claim 1, wherein
the event information includes
identification information of the image forming apparatus,
counter information that shows system operating status of the image forming apparatus at the time of replacement,
residual quantity of expendable supplies, and date and time of replacement, and
the identification information determining circuit updates contents of the management table based on the event information.

3. The management system according to claim 2, wherein
when the detected identification information is unknown, the identification information includes content showing that is not discriminable,
the identification information determining circuit determines not corresponding to shipped expendable supplies by the identification information that is not discriminable.

4. The management system according to claim 3, wherein
the identification information determining circuit determines not corresponding to shipped expendable supplies by the residual quantity of the expendable supplies in which the management table corresponds.

5. A control apparatus comprising:
a receiving circuit that receives event information including identification information of a container accompanying replacement of the container of expendable supplies from an image forming apparatus;
an identification information determining circuit that compares the identification information of the container included in received event information and a management table to manage shipped expendable supplies and determines whether the identification information of the container corresponds to the shipped expendable supplies; and
a notice circuit that notifies contents showing not corresponding to the image forming apparatus when the identification information of the container does not correspond to the shipped expendable supplies.

6. A controlling method comprising the steps of:
Receiving, by a receiving circuit, event information including identification information of a container accompanying replacement of the container of expendable supplies from an image forming apparatus;
Comparing, by an identification information determining circuit, the identification information of the container included in received event information and the management table to manage shipped expendable supplies and determining whether or not the identification information of the container corresponding to the shipped expendable supplies; and
Notifying, by a notice circuit, contents showing not corresponding to the image forming apparatus when the identification information of the container does not correspond to the shipped expendable supplies.
